(19) United States
(12) Patent Application Publication
(10) Pub. No.: US 2025/0244041 A1
(43) Pub. Date: Jul. 31, 2025

(54) APPARATUS AND METHOD FOR CONTROLLING AIR CONDITIONER USING COMFORTABLE TEMPERATURE AND SYSTEM COMPRISING THE APPARATUS

(71) Applicant: SEEDN CO., LTD, Seoul (KR)

(72) Inventors: Hyun Woong CHOI, Seongnam-si, Gyeonggi-do (KR); Won Jin HONG, Gwangju-si, Gyeonggi-do (KR)

(21) Appl. No.: 18/854,158

(22) PCT Filed: Mar. 31, 2023
(86) PCT No.: PCT/KR2023/004363

§ 371 Date: Oct. 23, 2024

(30) Foreign Application Priority Data
Apr. 4, 2022 (KR) 10-2022-0041691

(51) Int. Cl. F24F 11/65; F24F 110/10; F24F 110/12; F24F 130/10; F24F 130/20

(52) U.S. Cl. CPC F24F 11/65; F24F 2110/10; F24F 2110/12; F24F 2130/10; F24F 2130/20

(57) ABSTRACT

An apparatus and method for controlling an air conditioner using comfortable temperature and a system including the apparatus are disclosed. The disclosed apparatus for controlling an air conditioner includes a communication unit that receives an indoor temperature of an indoor zone measured by a temperature sensor and weather information of the zone provided by a weather server, respectively; and a control unit that sets a comfortable temperature of the zone based on the weather information and generates a drive control signal of the air conditioner based on the indoor temperature and the comfortable temperature. In this case, the comfortable temperature includes an off comfortable temperature, which is a perceived comfortable temperature of a user located in the zone when the air conditioner is turned off, and an on comfortable temperature, which is the perceived comfortable temperature of the user when the air conditioner is turned on.

### TECHNICAL FIELD

Embodiments of the present invention relate to an apparatus and method for controlling an air conditioner so as to maintain a comfortable temperature in an indoor zone in all seasons while minimizing power consumption of the air conditioner, and a system including the apparatus.

### BACKGROUND ART

An air conditioner is an apparatus that uses a refrigeration cycle to maintain a comfortable indoor temperature suitable for human activities. An air conditioner cools a room by sucking in hot air from the room, exchanging heat with a low-temperature refrigerant, and then discharging the heat-exchanged air into the room, or heats the room by the opposite action.

Generally, the air conditioner is controlled by direct manipulation of a person. For example, in the summer, when the indoor temperature is high, a user turns on the air conditioner, and determines the set temperature (i.e., set temperature) of the turned-on air conditioner low in order to quickly reduce the high indoor temperature.

Meanwhile, many users are located in spaces such as restaurants, cafes, and offices. Generally, managers of the spaces directly control driving of the air conditioner. However, there is a problem in which the air conditioner is not driven efficiently due to the ignorance or indifference of the manager.

For example, in the summer, when the manager determines the set temperature of the air conditioner high, the users may feel hot, and when the manager determines the set temperature of the air conditioner low, the users may feel cold. Accordingly, the users feel uncomfortable. Furthermore, in the summer, when the set temperature of the air conditioner is set low, the power consumption of the air conditioner increases, which causes the problem of increasing the electricity cost of the spaces.

Therefore, a technology is required to efficiently drive the air conditioner without the manager directly manipulating the air conditioner.

### DISCLOSURE

### Technical Problem

It is an object of the present invention to provide an apparatus and method for controlling an air conditioner capable of preventing unnecessary driving of an air conditioner, and a system including the apparatus.

It is another object of the present invention to provide an apparatus and method for controlling an air conditioner capable of minimizing power consumption of an air conditioner, and a system including the apparatus.

It is still another aspect of the present invention to provide an apparatus and method for controlling an air conditioner capable of efficiently setting a comfortable temperature based on weather information of an indoor zone, and a system including the apparatus.

The objects of the present invention are not limited to the above-described objects, and other objects and advantages of the present invention that are not described may be understood by the following description and will be more clearly appreciated by exemplary embodiments of the present invention. In addition, it may be easily appreciated that the objects and advantages of the present invention may be realized by means mentioned in the claims and a combination thereof.

### Technical Solution

According to an embodiment of the present invention, an apparatus for controlling an air conditioner installed in an indoor zone includes: a communication unit that receives an indoor temperature of the zone measured by a temperature sensor and weather information of the zone provided by a weather server, respectively; and a control unit that sets a comfortable temperature of the zone based on the weather information and generates a drive control signal of the air conditioner based on the indoor temperature and the comfortable temperature. In this case, the comfortable temperature includes an off comfortable temperature, which is a perceived comfortable temperature of a user located in the zone when the air conditioner is turned off, and an on comfortable temperature, which is the perceived comfortable temperature of the user when the air conditioner is turned on.

According to an embodiment of the present invention, a system for controlling an air conditioner installed in an indoor zone includes: a temperature sensor that measures an indoor temperature of the zone; a gateway that receives the indoor temperature from the temperature sensor; a management server that receives weather information of the zone provided from a weather server and the indoor temperature transmitted from the gateway, respectively, sets an off comfortable temperature, which is a perceived comfort temperature of a user located in the zone when the air conditioner is turned off, and an on comfortable temperature, which is the perceived comfort temperature of the user when the air conditioner is turned on, based on the weather information, and generates a drive control signal of the air conditioner based on the indoor temperature, the off comfortable temperature, and the on comfortable temperature; and a control module that receives the drive control signal transmitted from the management server through the gateway and transmits the drive control signal to the air conditioner.

According to an embodiment of the present invention, a method for controlling an air conditioner installed in an indoor zone, performed on a processor-based apparatus includes the steps of: receiving weather information of the zone provided from a weather server; setting an off comfortable temperature, which is a perceived comfort temperature of a user located in the zone, when the air conditioner is turned off and an on comfortable temperature, which is the perceived comfort temperature of the user located in the zone when the air conditioner is turned on, based on the weather information; receiving an indoor temperature measured in the zone; and generating a drive control signal of the air conditioner based on the indoor temperature, the off comfortable temperature, and the on comfortable temperature.

### Advantageous Effects

According to the present invention, by determining whether to turn on the air conditioner or determining whether to turn off the air conditioner using the off comfortable temperature, it is possible to prevent the unnecessary driving of the air conditioner while providing a comfortable indoor zone environment to the user.

In addition, according to the present invention, when the air conditioner is turned on or when the turned-off air conditioner is determined to be turned on, it is possible to determine the set temperature of the air conditioner using the on comfortable temperature. As a result, it is possible to provide the comfortable indoor zone environment to the user while minimizing the power consumption of the air conditioner.

In addition, according to the present invention, by setting the comfortable temperature by month and period using the outdoor weather information, it is possible to prevent the discomfort felt by the user due to the indoor temperature in the indoor zone in advance.

In addition, it should be understood that the effects of the present invention are not limited to the above effects, and include all effects that can be inferred from the configuration of the invention described in the detailed description or the claims of the present invention.

### BRIEF DESCRIPTION OF THE DRAWINGS

FIG. 1 is a diagram illustrating a schematic configuration of a space according to an embodiment of the present invention.

FIG. 2 is a diagram illustrating a schematic configuration of a system for controlling an air conditioner according to an embodiment of the present invention.

FIG. 3 is a diagram illustrating a schematic configuration of a management server according to an embodiment of the present invention.

FIG. 4 is a diagram illustrating a graph of a first temperature change function according to an embodiment of the present invention.

FIG. 5 is a diagram illustrating a graph of a second temperature change function according to an embodiment of the present invention.

### BEST MODE

The present invention may be variously modified and have several embodiments, and thus, specific embodiments will be illustrated in the drawings and be described in detail. However, it is to be understood that the present invention is not limited to a specific embodiment, but includes all modifications, equivalents, and substitutions without departing from the scope and spirit of the present invention. Throughout the drawings, similar components will be denoted by similar reference numerals.

The terms such as ‘first’, ‘second’, or the like, may be used to describe various components, but these components are not to be construed as being limited to these terms. The terms are used only in order to distinguish one component from another component. The term “and/or” includes a combination of a plurality of related described items or any one of the plurality of related described items.

It is to be understood that when one component is referred to as being “connected to” or “coupled to” another component, one component may be connected directly to or coupled directly to another component or be connected to or coupled to another component with the other component interposed therebetween. On the other hand, it is to be understood that when one component is referred to as being “connected directly to” or “coupled directly to” another component, it may be connected to or coupled to another component without the other component interposed therebetween.

The terms used in the present specification are used only in order to describe specific embodiments rather than limiting the present invention. Singular forms include plural forms unless the context clearly indicates otherwise. It is to be understood that the term “include” or “have” used here specifies the presence of features, numbers, steps, operations, components, parts, or combinations thereof mentioned in the present specification, or combinations thereof, but does not preclude the presence or addition of one or more other features, numbers, steps, operations, components, parts, or combinations thereof.

Unless indicated otherwise, it is to be understood that all the terms used in the specification including technical and scientific terms have the same meaning as those that are generally understood by those who skilled in the art. The terms generally used and defined by a dictionary should be interpreted as having the same meanings as meanings within a context of the related art and should not be interpreted as having ideal or excessively formal meanings unless being clearly defined otherwise in the present specification.

Hereinafter, the embodiments of the present invention will be described in detail with reference to the accompanying drawings.

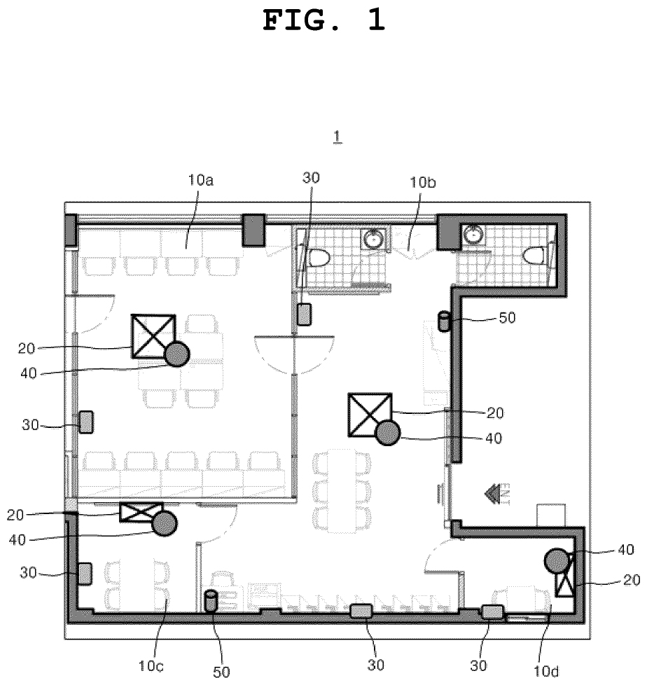

FIG. 1 is a diagram illustrating a schematic configuration of a space 1 according to an embodiment of the present invention.

Referring to FIG. 1, the space 1 includes a plurality of zones 10a, 10b, 10c, and 10d. The plurality of zones 10a, 10b, 10c, and 10d may be separated from each other by inner walls. By being separated by the inner walls, the indoor temperature and humidity of each of the plurality of zones 10a, 10b, 10c, and 10d may be different from each other.

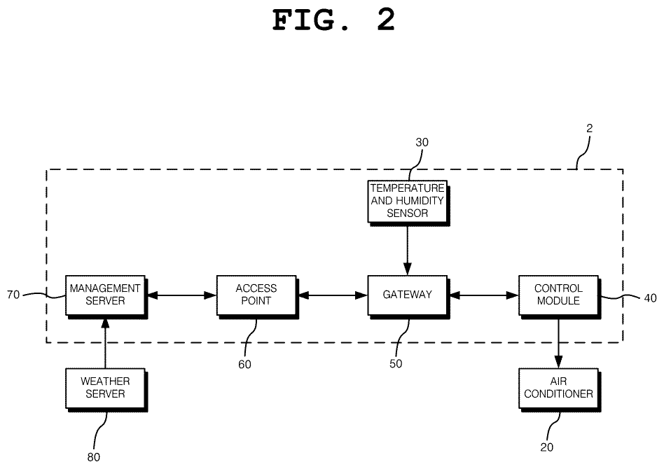

An air conditioner 20, a temperature and humidity sensor 30, and a control module 40 may be installed in each of the plurality of zones 10a, 10b, 10c, and 10d. In addition, a gateway 50 may be installed in an zone 10b of at least some of the plurality of zones 10a, 10b, 10c, and 10d. Meanwhile, although not illustrated in FIG. 1, an access point 60 (see FIG. 2) may be additionally installed in a specific zone among the plurality of zones 10a, 10b, 10c, and 10d.

Hereinafter, the present invention will be described assuming that the zone 10b, where the gateway 50 is installed, is a target zone 10. However, the present invention is not limited thereto, and the contents of the present invention to be described below may be applied to all of the plurality of zones 10a, 10b, 10c, and 10d.

FIG. 2 is a diagram illustrating a schematic configuration of a system 2 for controlling an air conditioner according to an embodiment of the present invention.

Referring to FIG. 2, the system 2 for controlling an air conditioner includes the temperature and humidity sensor 30, the control module 40, the gateway 50, the access point 60, and a management server 70.

The temperature and humidity sensor 30 may measure the indoor temperature and humidity of the target zone 10. For this purpose, the temperature and humidity sensor 30 may include a temperature sensor module and a humidity sensor module.

The temperature and humidity sensor 30 may be installed in a location where the temperature and humidity of a zone where people are mainly active may be measured, but is not limited thereto, and the temperature and humidity sensor 30 may be built into the air conditioner 20.

The temperature and humidity sensor 30 may perform communication with other electronic devices within the target zone 10. To this end, the temperature and humidity sensor 30 may include a short-range communication module. For example, the temperature and humidity sensor 30 may be equipped with a Bluetooth communication module, but the present invention is not limited thereto.

The control module 40 may be a device that transmits a drive control signal to the air conditioner 20 to control the drive of the air conditioner 20. The control module 40 may be installed in a specific part of the target zone 10 adjacent to the air conditioner 20. As described below, the drive control signal is generated in the management server 70 and may be transmitted from the management server 70 to the control module 40 via the access point 60 and the gateway 50.

To this end, the control module 40 may include a short-range communication module and an infrared data association (IrDA) module. For example, the control module 40 may include a Bluetooth communication module, but the present invention is not limited thereto.

The gateway 50 may perform communication with each of the temperature and humidity sensor 30, the control module 40, and the access point 60. To this end, the gateway 50 may include a first short-range communication module for communication connection with the temperature and humidity sensor 30 and the control module 40, and a second short-range communication module for communication connection with the access point 60. For example, the first short-range communication module may be a Bluetooth communication module, and the second short-range communication module may be a wireless fidelity (WiFi) communication module, but the present invention is not limited thereto.

The gateway 50 may receive indoor temperature and humidity information from the temperature and humidity sensor 30 and then transmit the received indoor temperature and humidity information to the access point 60. In addition, the gateway 50 may receive a drive control signal of the air conditioner 20, which will be described later, from the access point 60 and then transmit the received drive control signal to the control module 40. In addition, the gateway 50 may also receive data related to the driving of the air conditioner 20 from the control module 40.

The access point 60 may relay communication between the gateway 50 and the management server 70. To this end, the access point 60 may include the second short-range communication module and a long-range communication module.

The management server 70 may be a device that actually controls the air conditioner 20. The management server 70 may be connected to the access point 60 and a weather server 80 for communication. The management server 70 may receive the indoor temperature and humidity information of the target zone 10 from the access point 60, and receive weather information of the target zone 10 from the weather server 80. The management server 70 may generate the drive control signal of the air conditioner 20 using the indoor temperature and humidity information and the weather information of the target zone 10, and transmit the drive control signal to the access point 60.

The weather server 80 may be a server that provides weather information for each administrative zone. The weather information may be predicted information. The weather information may include weather information by time zone of the day and average weather information of the day. The weather information by time zone of the day may include outdoor temperature, a cloud amount, precipitation probability, humidity, etc., and the average weather information of the day may include minimum outdoor temperature, maximum outdoor temperature, an average cloud amount, average precipitation probability, average humidity, etc. The weather information may include both weather information of a current day and weather information of a past day. Meanwhile, the cloud amount may correspond to solar radiation quantity.

Hereinafter, the management server 70 will be described in more detail.

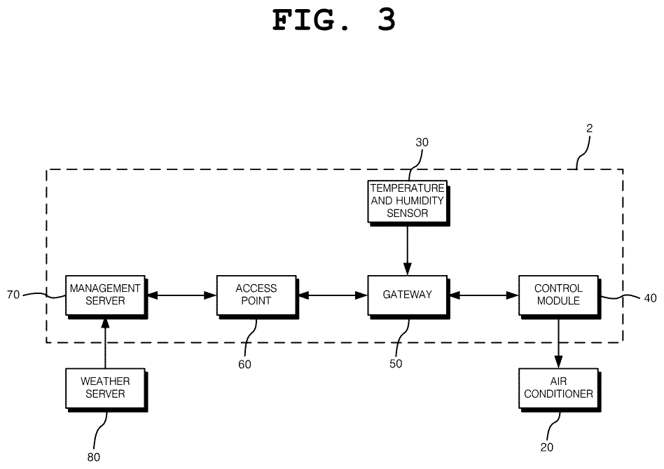

FIG. 3 is a diagram illustrating a schematic configuration of the management server 70 according to one embodiment of the present invention.

Referring to FIG. 3, the management server 70 may control the driving of the air conditioner 20 by day and may include a communication unit 710, a control unit 720, and a storage unit 730. Hereinafter, the functions of each component will be described in detail.

The communication unit 710 may be a module that performs communication with the access point 60 and the weather server 80. For example, the communication unit 710 may include a long-range communication module implemented in a wired or wireless manner, but the present invention is not limited thereto.

As described above, the communication unit 710 may receive the indoor temperature and humidity information measured by the temperature and humidity sensor 30, and receive the weather information of the target zone 10 provided by the weather server 80.

The control unit 720 may include a memory and a processor. The memory may be a volatile and/or nonvolatile memory, and may store instructions or data related to at least one other component of the management server 70. The processor may include one or more of a central processing unit (CPU), an application processor, or a communication processor.

The control unit 720 may control the communication unit 710 and generate the drive control signal of the air conditioner 20. As described above, the indoor temperature information, the indoor humidity information, and the weather information of the target zone 10 may be received through the communication unit 710, and the control unit 720 may generate the drive control signal based on the received information. In order to generate the drive control signal, the control unit 720 may use the information to produce processing information.

Meanwhile, the control unit 720 may generate the processing information in real time at the time (control time) when the air conditioner 20 is to be controlled, and may also generate the processing information in advance before the control time.

The storage unit 730 may store a control command of the air conditioner 20, status information of the control module 40, etc.

Meanwhile, the control unit 720 may generate the drive control signal of the air conditioner 20 using various types of information. Here, various types of information may include a comfortable temperature, thermal characteristics of the target zone 10, and first and second temperature variations of the target zone 10. In this case, the comfortable temperature, the first and second temperature variations of the target zone 10 may be calculated by the control unit 720 based on the weather information of the target zone 10.

Hereinafter, the information will be described in more detail.

### 1. Comfortable Temperature

The comfortable temperature may be defined as a perceived temperature that a user located in the target zone 10 feels comfortable.

The comfortable temperature may be set differently by season. For example, the comfortable temperature in summer may be higher than the comfortable temperature in winter.

The comfortable temperature may also be set differently by period included in the target day for which the air conditioner 20 is to be controlled. Here, multiple periods may mean sequential time intervals included in the target day.

Multiple periods may be set based on an operating schedule for the space 1 or the target zone 10. For example, when the space 1 is a cafe and business hours of the cafe are “8:00 to 20:00”, the operating schedule may be set to “7:00 to 21:00”.

A length of the period, i.e., a unit time for the period may be set in various ways. For example, the unit time defining the period may be set to 1 hour. Therefore, the comfortable temperature in the period of “7:00 to 7:59” and the comfortable temperature in the period of “8:00 to 8:59” may be set individually. However, the present invention is not limited thereto, and the unit time may be set in various ways.

Meanwhile, the comfortable temperature may include an off comfortable temperature and an on comfortable temperature. The off comfortable temperature may be defined as the perceived temperature that the user located in the target zone 10 feels comfortable when the air conditioner 20 is turned off. The on comfortable temperature may be defined as the perceived temperature that the user located in the target zone 10 feels comfortable when the air conditioner 20 is turned on.

Specifically, the perceived temperature of the user may be different from each other due to the driving of the air conditioner 20, for example, the output of cold air/hot air from the air conditioner 20. That is, the perceived temperature of the user changes depending on an external stimulus. For example, when the cold air touches a user's skin, the perceived temperature may decrease, and when the hot air touches the user's skin, the perceived temperature may increase. Therefore, the management server 70 may apply the change in the perceived temperature of the user according to the external stimulus to classify the comfortable temperature into the off comfortable temperature and the on comfortable temperature, and control the driving of the air conditioner 20 using both the off comfortable temperature and the on comfortable temperature.

According to an embodiment, the off comfortable temperature may be used when changing the state of the air conditioner 20. In this case, the change in the state of the air conditioner 20 may include a first state change that changes the state of the air conditioner 20 from turn off to turn on, and a second state change that changes the state of the air conditioner 20 from turn on to turn off. That is, the off comfortable temperature may be used when determining whether to turn on the turned off air conditioner 20, or may be used when determining whether to turn off the turned on air conditioner 20. The management server 70 may prevent unnecessary driving of the air conditioner 20 while providing a comfortable indoor zone environment to the user by using the off comfortable temperature. This will be described below.

According to the embodiment, when the air conditioner 20 is turned on or when the turned-off air conditioner 20 is determined to be turned on, the on comfortable temperature may be used when determining the set temperature of the air conditioner 20. The management server 70 may minimize the power consumption of the air conditioner 20 while providing the comfortable zone environment to the user by using the on comfortable temperature. This will be described below.

Meanwhile, the off comfortable temperature and the on comfortable temperature may be individually set for each of the multiple periods. In this case, the off comfortable temperature and the on comfortable temperature may be different by period.

According to an embodiment, the on comfortable temperature may be set higher or lower than the off comfortable temperature by a predefined critical temperature. This is due to the “change in the perceived temperature of the user due to the external stimulus” described above.

That is, the off comfortable temperature may be set, and the on comfortable temperature may be set by adding or subtracting the critical temperature to the off comfortable temperature. Accordingly, the setting of the off comfortable temperature and the on comfortable temperature may be simplified.

As an example, when the air conditioner 20 is driven in a cooling mode, the perceived temperature of the user may be lowered by the cold air, so the on comfortable temperature may be set higher than the off comfortable temperature by the critical temperature. In addition, when the air conditioner 20 is driven in a heating mode, the perceived temperature of the user may be higher by the hot air, so the on comfortable temperature may be set lower than the off comfortable temperature by the critical temperature.

Meanwhile, the critical temperature may be a fixed temperature value. For example, the critical temperature may be 1° C., but the present invention is not limited thereto. Alternatively, the critical temperature may be defined based on the driving characteristics of the air conditioner 20. The driving characteristics of the air conditioner 20 may include driving efficiency of the air conditioner 20, an installation location of the air conditioner 20, a production year of the air conditioner 20, an installation height of the air conditioner 20, etc. The driving efficiency of the air conditioner 20 may be defined as driving efficiency at a specific set temperature of the air conditioner 20.

According to an embodiment, the off comfortable temperature and the on comfortable temperature may be set in a temperature range format. That is, the off comfortable temperature may be set to an off comfortable temperature range, and the on comfortable temperature may be set to an on comfortable temperature range. For example, the off comfortable temperature range may be set to “22.5° C. to 23.5° C.”, and the on comfortable temperature range may be set to “23.5° C. to 24.5° C.”.

According to an embodiment, the reference comfortable temperature of the reference day is preset, and the comfortable temperature of the target day may be set by reflecting the weather information target day in the reference comfortable temperature. That is, the comfortable temperature of the target day may be set by adjusting the reference comfortable temperature of the reference day according to the weather information of the target day of the target zone 10.

Here, the reference day may be defined as a specific day of the target month that includes the target day. The reference day may correspond to a sunny day without clouds and precipitation, but the present invention is not limited thereto.

The reference comfortable temperature may be set by sequential period of the target day. In addition, the off comfortable temperature may be set by period based on the reference comfortable temperature, and the on comfortable temperature may be set by adding or subtracting a critical temperature to or from the off comfortable temperature. However, the present invention is not limited thereto.

According to an embodiment, a representative reference comfortable temperature, which is a reference comfortable temperature of a reference period included in a reference day, may be preset. For example, the reference day may be a clear day without clouds or precipitation, and the reference period may be “3:00 to 3:59”. The reference comfortable temperature may be preset based on weather information of a reference time of the reference day received from the weather server 80.

According to an embodiment, a predefined period correction parameter may be applied to the representative reference comfortable temperature, and a reference comfortable temperature by period may be set. Here, the period correction parameter may be defined based on at least one of a sunrise/sunset time of a reference day and an average outdoor temperature of a reference day.

For example, when the reference day is a specific day of a reference month, the sunrise/sunset time of the reference day may be an average sunrise/sunset time of multiple days included in the reference month, and the average outdoor temperature of the reference day may be the average outdoor temperature of multiple days included in the reference month. The average sunrise/sunset time and the average outdoor temperature of multiple days of the reference month may be calculated based on the weather information of the reference month provided by the weather server 80.

Hereinafter, the operation of the control unit 720 of the management server 70, which sets the comfortable temperature by reflecting the weather information of the target day in the reference comfortable temperature, will be described in more detail. In this case, the operation of the control unit 720 described below may be performed equally by period, and may be applied equally to the off comfortable temperature and the on comfortable temperature, respectively.

### 1.1. Setting of Comfortable Temperature Considering Outdoor Temperature

According to an embodiment, the control unit 720 may calculate the difference between the outdoor temperature of the target day and the outdoor temperature of the reference day, and adjust the reference comfortable temperature according to the difference between the temperature of the target day and the temperature of the reference day to set the comfortable temperature of the target day.

Here, the outdoor temperatures of the target day and the reference day may be the period-specific outdoor temperatures of the target day and the reference day, or may be the average outdoor temperatures of the target day and the reference day. In this case, the average outdoor temperature of the target day and the average outdoor temperature of the reference day may be provided by the weather server 80. Alternatively, the control unit 720 may receive minimum and maximum outdoor temperatures of the target day and the reference day, respectively, from the weather server 80, and calculate the average outdoor temperatures of the target day and the reference day, respectively, based on the minimum and maximum outdoor temperatures.

Specifically, when the outdoor temperatures of the reference day and the target day are the same, the comfortable temperature of the target day may be the same as the comfortable temperature of the reference day. In addition, when the outdoor temperature of the target day is higher than the outdoor temperature of the reference day, the comfortable temperature of the target day should be lower than the comfortable temperature of the reference day, depending on the change in the perceived temperature of the user due to the external stimulus (temperature). In addition, when the outdoor temperature of the target day is lower than the outdoor temperature of the reference day, the comfortable temperature of the target day should be higher than the comfortable temperature of the reference day, depending on the change in the perceived temperature of the user due to the external stimulus (temperature). Therefore, the control unit 720 may set the comfortable temperature of the target day by comparing the outdoor temperature of the reference day with the outdoor temperature of the target day to adjust the reference comfortable temperature.

As an example, the control unit 720 may set the comfortable temperature of the target day based on the following Equation 1.

$$[ Equation 1 ]$$

$$Comfortable temperature of target day = Reference comfortable temperature - α Δ Ta$$

wherein, ΔTa represents the difference between the temperature of the target day and the temperature of the reference day, and α represents the temperature adjustment parameter, respectively. The temperature adjustment parameter may have different values depending on whether the air conditioner 20 is in the cooling mode or heating mode.

Tables 1 and 2 below represent the concept of calculating the comfortable temperature of the target day according to the outdoor temperature based on Equation 1. In this case, the comfortable temperature was defined as the comfortable temperature range.

TABLE 1
Cooling mode (α = 0.4)

| Outdoor | Outdoor | | Reference | Comfortable |
|---|---|---|---|---|
| temperature of | temperature of | | comfortable | temperature range |
| target day | reference day | ΔTa | temperature | of target day |
| (° C.) | (° C.) | (° C.) | range (° C.) | (° C.) |
| 29.2 | 27.5 | 1.7 | 24.5 to 25.5 | 23.82 to 24.82 |
| 29.4 | 27.5 | −2.1 | 24.5 to 25.5 | 25.34 to 26.34 |

TABLE 2
Heating mode (α = 0.3)

| Outdoor | Outdoor | | Reference | Comfortable |
|---|---|---|---|---|
| temperature of | temperature of | | comfortable | temperature range |
| target day | reference day | ΔTa | temperature | of target day |
| (° C.) | (° C.) | (° C.) | range (° C.) | (° C.) |
| 3.3 | 1.1 | 2.2 | 22.5 to 23.5 | 21.84 to 22.84 |
| −0.9 | 1.1 | −2.0 | 22.5 to 23.5 | 23.1 to 24.1 |

### 1.2. Setting of Comfortable Temperature Considering Cloud Amount

According to an embodiment, the control unit 720 may calculate the difference between the cloud amount of the target day and the cloud amount of the reference day, and adjust the reference comfortable temperature according to the difference in the cloud amounts of the target day and the reference day to set the comfortable temperature of the target day. The cloud amount may correspond to solar radiation quantity.

Here, the cloud amounts of the target day and the reference day may be the period-specific cloud amounts of the target day and the reference day, or the average cloud amounts of the target day and the reference day. In this case, the period-specific cloud amounts or the average cloud amounts of the target day and the reference day, respectively, may be provided by the weather server 80.

Specifically, when the cloud amounts of the reference day and the target day are the same, the comfortable temperature of the target day may be the same as the comfortable temperature of the reference day. When the cloud amount of the target day is higher than the cloud amount of the reference day, the solar radiation quantity of the target day is lower than the solar radiation quantity of the reference day, so the comfortable temperature of the target day should be higher than the comfortable temperature of the reference day according to the change in the perceived temperature of the user due to the external stimulus (solar radiation quantity). In addition, when the cloud amount of the target day is lower than the cloud amount of the reference day, the solar radiation quantity of the target day is higher than the solar radiation quantity of the reference day, so the comfortable temperature of the target day should be lower than the comfortable temperature of the reference day according to the change in the perceived temperature of the user due to the external stimulus (solar radiation quantity). Therefore, the control unit 720 may set the comfortable temperature of the target day by comparing the cloud amount of the reference day with the cloud amount of the target day to adjust the reference comfortable temperature.

As an example, the control unit 720 may set the comfortable temperature of the target day based on the following Equation 2.

$$[ Equation 2 ]$$

$$Comfortable temperature of target day = Reference comfortable temperature + β Δ C$$

wherein, ΔC represents the difference between the cloud amount of the target day and the cloud amount the reference day, and β represents the cloud amount adjustment parameter, respectively. The cloud amount adjustment parameter may have different values depending on whether the air conditioner 20 is in the cooling mode or heating mode.

Meanwhile, the cloud amount may be defined as a level. For example, the level of the cloud amount may be 5 levels, and the cloud amount increases as it goes from a low level to a high level.

Table 3 below expresses the concept of calculating the comfortable temperature of the target day according to the cloud amount according to Equation 2. In this case, the comfortable temperature was defined as the comfortable temperature range. In addition, the cloud amount is set as a level, and the reference day is set to level 1 without clouds.

TABLE 3
Cloud amount (β = 0.2)

| | | | Reference | Comfortable |
|---|---|---|---|---|
| | | | comfortable | temperature range |
| Cloud amount | Cloud amount of | | temperature | of target day |
| of target day | reference day | ΔC | range (° C.) | (° C.) |
| 1 | 1 | 0 | 24.5 to 25.5 | 24.5 to 25.5 |
| 2 | 1 | 1 | 24.5 to 25.5 | 24.7 to 25.7 |
| 3 | 1 | 2 | 24.5 to 25.5 | 24.9 to 25.9 |
| 4 | 1 | 3 | 24.5 to 25.5 | 25.1 to 26.1 |
| 5 | 1 | 4 | 24.5 to 25.5 | 25.3 to 26.3 |

### 1.3. Setting of Comfortable Temperature According to Precipitation

According to an embodiment, the control unit 720 may calculate the difference between the precipitation of the target day and the precipitation of the reference day, and adjust the reference comfortable temperature according to the difference in the precipitations of the target day and the reference day to set the comfortable temperature of the target day.

Here, the precipitation of the target day and the precipitation of the reference day may be the period-specific precipitations of the target day and the reference day, or may be the average precipitations of the target day and the reference day. In this case, the period-specific precipitations or the average precipitations of each of the target day and the reference day may be provided by the weather server 80.

In detail, the precipitation information of the day (target day and the reference day) may include a precipitation probability of day and a precipitation type of day. The precipitation probability may be expressed as a percentage, and the precipitation type may include snow, rain, etc. In this case, the control unit 720 may determine that the precipitation has occurred when the precipitation probability is greater than or equal to a preset threshold probability, and determine that the precipitation has not occurred when the precipitation probability is less than the threshold probability. The threshold probability may be experimentally or empirically set, and for example, may be 80%. However, the present invention is not limited thereto.

As described above, the reference day may be a day without precipitation. When it rains in the summer, the user may feel colder than on a day without rain. In addition, when it snows in the winter, the user may feel warmer than on a day without snow.

Therefore, assuming that the precipitation does not occur on the reference day, when the precipitation does not occur on the target day, the comfortable temperature of the target day may be the same as the comfortable temperature of the reference day. When it rains on the target day, the comfortable temperature of the target day should be higher than the comfortable temperature of the reference day depending on the change in the perceived temperature of the user due to the external stimuli. When it snows on the target day, the comfortable temperature of the target day should be lower than the comfortable temperature of the reference day depending on the change in the perceived temperature of the user due to the external stimuli. Therefore, the control unit 720 may set the comfortable temperature of the target day by comparing the precipitation of the reference day with the precipitation of the target day to adjust the reference comfortable temperature.

As an example, the control unit 720 may set the comfortable temperature of the target day based on the following Equation 3.

$$[ Equation 3 ]$$

$$Comfortable temperature of target day = Reference comfortable temperature - γ Δ R - δ Δ S$$

wherein, ΔR represents a first precipitation difference for rain, ΔS represents a second precipitation difference for snow, γ represents a rain adjustment parameter, and δ represents a snow adjustment parameter, respectively. The rain adjustment parameter and the snow adjustment parameter may have different values depending on whether the air conditioner 20 is in the cooling mode or heating mode.

Table 4 below expresses the concept of calculating the comfortable temperature of the target day according to the precipitation based on Equation 3. In this case, the comfortable temperature was defined as the comfortable temperature range. In addition, when it rains or snows, R and S have a value of “1”, and when it does not rain or snow, R and S have a value of “0”. In addition, the reference day is a day when the precipitation does not occur, and R and S are set to “0”.

TABLE 4
Whether it rains or not (γ = 0.3, δ = 0.2)

| | | | | Reference | Comfortable |
|---|---|---|---|---|---|
| Whether it | Whether snow | | | comfortable | temperature range |
| rains on | occurs on | | | temperature | of target day |
| target day | target day | ΔR | ΔS | range (° C.) | (° C.) |
| 0 | 0 | 0 | 0 | 24.5 to 25.5 | 24.5 to 25.5 |
| 1 | 0 | 1 | 0 | 24.5 to 25.5 | 24.8 to 25.8 |
| 0 | 1 | 0 | 1 | 24.5 to 25.5 | 24.3 to 25.3 |

### 1.4. Setting of Comfortable Temperature Considering all of Outdoor Temperature, Cloud Amount, and Precipitation

According to an embodiment, the control unit 720 may set the comfortable temperature of the target day by adjusting the reference comfortable temperature according to the difference between the outdoor temperature of the target day and the outdoor temperature of the reference day, the difference between the cloud amount of the target day and the cloud amount of the reference day, and the difference between the precipitation of the target day and the precipitation of the reference day. This is similar to the contents described above.

As an example, the control unit 720 may set the comfortable temperature of the target day based on the following Equation 4.

$$[ Equation 4 ]$$

$$Comfortable temperature of target day = Reference comfortable temperature - αΔ Ta + βΔ C + y Δ R - δ Δ S$$

wherein, the temperature adjustment parameter α, the cloud amount adjustment parameter β, the rain adjustment parameter Y, and the snow adjustment parameter δ may differ from the values when the indoor temperature, the cloud amount, and precipitation are considered alone.

In short, the management server 70 may set the comfortable temperature by day and period, and at the same time adjust the comfortable temperature using the weather information of the target zone 10 to implement a comfortable indoor temperature of the indoor zone suitable for the outside weather, thereby preventing the discomfort felt by the user located in the target zone 10 due to the indoor temperature in advance.

### 2. First Temperature Variation

The first temperature variation may be defined as a temperature variation per unit time of the target zone 10 when the air conditioner 20 is turned off.

The first temperature variation may be set based on the thermal characteristics of the target zone 10. In this case, the thermal characteristics of each of the plurality of zones 10a, 10b, 10c, and 10d may be different, and therefore, the first temperature variation may be set individually for each of the plurality of zones 10a, 10b, 10c, and 10d.

Here, the thermal characteristics of the target zone 10 may be related to the “influence of the change in external environment on the change in the indoor temperature of the target zone 10.”

For example, a change in indoor temperature of a specific zone may be relatively more influenced by the indoor/outdoor temperature difference than a change in indoor temperature of other zones, so the indoor temperature variation of the specific zone may be higher than indoor temperature variations of other zones.

According to an embodiment, the thermal characteristics may have a proportional relationship with the influence by the indoor/outdoor temperature difference. That is, the lower the influence by the indoor/outdoor temperature difference, the lower the thermal characteristics of the target zone 10 may be set, and the higher the influence by the indoor/outdoor temperature difference, the higher the thermal characteristics of the target zone 10 may be set. In other words, as the thermal characteristics of the target zone 10 are lower, the temperature of the target zone 10 may be maintained or less changed even if the higher the indoor/outdoor temperature difference increases.

According to an embodiment, the thermal characteristics of the target zone 10 may be preset based on at least one of a separation distance between the target zone 10 and the outside of the space 1 and insulation efficiency of the target zone 10. For example, the insulation efficiency of the target zone 10 may include a material of an interior wall finishing material of the target zone 10, the number of doors and/or windows provided in the target zone 10, the installation direction of the doors and/or windows, the presence or absence of thermal coating film treatment of the windows, the degree of window tinting, etc.

For example, the larger the separation distance and the higher the insulation efficiency of the inner wall finishing material of 10, the target zone lower the the thermal characteristics may be. When the thermal characteristics are low, even if the indoor/outdoor temperature difference is large, the indoor temperature variation of the target zone 10 may be relatively low compared to the indoor temperature variations of other zones with high thermal characteristics.

In addition, the first temperature variation may be set further based on the first temperature difference which is the difference between the indoor temperature of the target zone 10 and the outdoor temperature of the target zone 10. Here, the first temperature difference may be defined as the value obtained by subtracting the outdoor temperature from the indoor temperature. The larger the first temperature difference, the larger the temperature variation per unit time of the target zone 10 when the air conditioner 20 is turned off.

In short, the first temperature variation may be set based on the first temperature difference and the thermal characteristics of the target zone 10.

According to an embodiment, the first temperature variation may be defined as a predefined function, that is, a first temperature change function. The first temperature variation may have a form of a quadratic function. In this case, a variable of the first temperature change function may be the indoor/outdoor temperature difference, a constant of the first temperature change function may be predefined based on the thermal characteristics of the target zone 10, and the output of the first temperature change function may be the first temperature variation. In this case, the first temperature difference may be substituted into the variable (i.e., the indoor/outdoor temperature difference) of the first temperature change function, so the first temperature variation according to the first temperature difference may be calculated. The first temperature change function may be expressed as shown in the following Equation 5.

$$f ( Δ {T}_{D ( o - i )} ) = a Δ {T}_{D ( o - i )}^{2} + b Δ {T}_{D ( o - i )} + c \qquad [ Equation 5 ]$$

wherein, ΔT_{D(0-1)} represents the indoor/outdoor temperature difference, f(ΔT_{D (o-i)}) represents the first temperature variation, and a, b, and c each represent parameters defined by the thermal characteristics of the target zone 10.

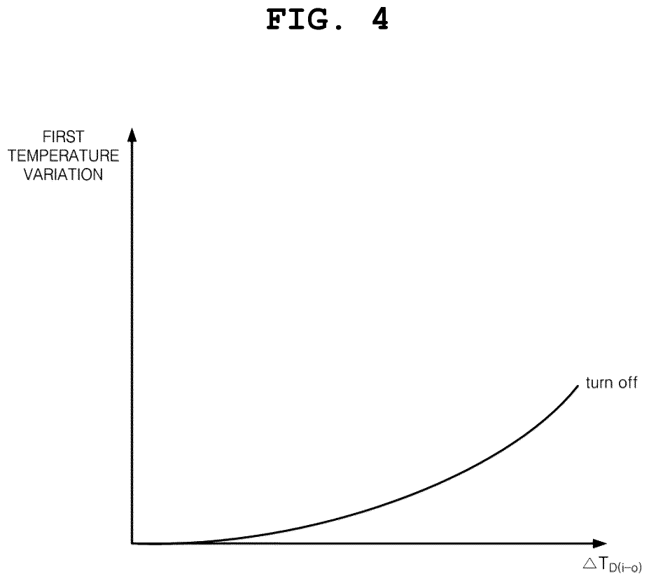

FIG. 4 is a diagram illustrating a graph of the first temperature change function according to an embodiment of the present invention. Referring to FIG. 4, as the indoor/outdoor temperature difference increases, an output value of the first temperature change function may increase nonlinearly.

### 3. Second Temperature Variation

The second temperature variation may be defined as a temperature variation per unit time of the target zone 10 when the air conditioner 20 is turned on.

The second temperature variation may be set based on the thermal characteristics of the target zone 10. In this case, the thermal characteristics of each of the plurality of zones 10a, 10b, 10c, and 10d may be different, and therefore, the second temperature variation may be set individually for each of the plurality of zones 10a, 10b, 10c, and 10d.

The thermal characteristics of the target zone 10 for setting the second temperature variation may be preset based on at least one of the separation distance between the target zone 10 and the outside of the space 1, the insulation efficiency of the inner wall finishing material of the target zone 10, and the driving characteristics of the air conditioner 20. That is, since the second temperature variation assumes that the air conditioner 20 is turned on, the thermal characteristics of the target zone 10 for setting the second temperature variation should consider the driving characteristics of the air conditioner 20. As described above, the driving characteristics of the air conditioner 20 may include the driving efficiency of the air conditioner 20, the installation location of the air conditioner 20, and the production year of the air conditioner 20.

In addition, the second temperature variation may be set based on the first temperature difference which is the difference between the indoor temperature of the target zone 10 and the outdoor temperature of the target zone 10. The description of the first temperature difference has been described above.

In addition, the second temperature variation may be set further based on the set temperature (i.e., the desired temperature when the air conditioner 20 is driven) of the air conditioner 20. For example, when the air conditioner 20 is driven in the heating mode, the indoor temperature of the target zone 10 may increase more quickly as the air conditioner 20 is driven at a higher set temperature. In addition, when the air conditioner 20 is driven in the cooling mode, the indoor temperature of the target zone 10 may decrease more quickly as the air conditioner 20 is driven at a lower set temperature. Therefore, the second temperature variation should consider the set temperature of the air conditioner 20.

In short, the second temperature variation may be set based on the first temperature difference, the thermal characteristics of the target zone 10, and the set temperature of the air conditioner 20.

According to an embodiment, the second temperature variation may be defined as the predefined function, that is, the second temperature change function for each set temperature. The second temperature change function for each set temperature may have a form of a quadratic function. In this case, the variable of the second temperature change function for each set temperature may be the indoor/outdoor temperature difference, the constant of the first temperature change function may be predefined based on the thermal characteristics of the target zone 10 and the set temperature of the air conditioner 20, and the output of the second temperature change function may be the second temperature variation. In this case, the first temperature difference may be substituted into the variable (i.e., the indoor/outdoor temperature difference) of the second temperature change function, so the second temperature variation according to the first temperature difference may be calculated. The second temperature change function may be expressed similar to the above Equation 5.

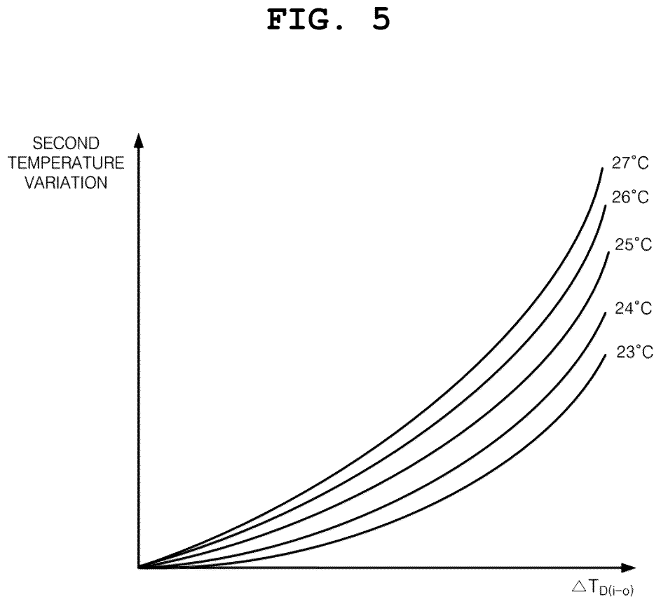

FIG. 5 is a diagram illustrating a graph of the second temperature change function according to an embodiment of the present invention. Referring to FIG. 5, a graph may be expressed for each set temperature of the air conditioner 20. In this case, as the indoor/outdoor temperature difference increases, the output value of the first temperature change function may increase nonlinearly. In addition, as the set temperature of air conditioner 20 increases, the second temperature variation may increase.

In short, the management server 70 may control the driving of the air conditioner 20 according to various algorithms by using the off comfortable temperature, the on comfortable temperature, the first temperature variation, and the second temperature variation.

In addition, the embodiments of the present invention may be implemented in a form of program commands that may be executed through various computer means and may be recorded in a computer-readable recording medium. The computer-readable recording medium may include program commands, data files, data structures or the like, alone or in a combination thereof. The program commands recorded in the computer-readable recording medium may be especially designed and configured for the present invention or be known to those skilled in a field of computer software. Examples of the computer-readable recording medium may include a magnetic medium such as a hard disk, a floppy disk, and a magnetic tape; an optical recording medium such as a CD-ROM, a DVD; a magneto-optical medium such as a floptical disk; and a hardware device specially constituted to store and perform program commands such as a ROM, a RAM, a flash memory, or the like. Examples of the program commands include high-level language codes capable of being executed by a computer using an interpreter, or the like, as well as machine language codes made by a compiler. The above-described hardware device may be constituted to be operated as one or more software modules to perform operations according to the embodiments of the present invention, and vice versa.

Hereinabove, although the present invention has been described by specific matters such as detailed components, exemplary embodiments, and the drawings, these have been provided only for assisting in the entire understanding of the present invention. Therefore, the present invention is not limited to the exemplary embodiments, and various modifications and changes may be made from this description by those skilled in the art to which the present invention pertains. Therefore, the spirit of the present invention should not be limited to these exemplary embodiments, but the claims and all of modifications equal or equivalent to the claims are intended to fall within the scope of the spirit of the present invention.

1. An apparatus for controlling an air conditioner installed in an indoor zone, comprising:
a communication unit that receives an indoor temperature of the zone measured by a temperature sensor and weather information of the zone provided by a weather server, respectively; and
a control unit that sets a comfortable temperature of the zone based on the weather information and generates a drive control signal of the air conditioner based on the indoor temperature and the comfortable temperature,
wherein the comfortable temperature includes an off comfortable temperature, which is a perceived comfortable temperature of a user located in the zone when the air conditioner is turned off, and an on comfortable temperature, which is the perceived comfortable temperature of the user when the air conditioner is turned on.

2. The apparatus of claim 1, wherein the off comfortable temperature is used when changing a state of the air conditioner, and
the change in the state of the air conditioner includes a first state change that changes the state of the air conditioner from turn-off to turn-on and a second state change that changes the state of the air conditioner from turn-on to turn-off.

3. The apparatus of claim 1, wherein the on comfortable temperature is used when determining a set temperature of the air conditioner.

4. The apparatus of claim 1, wherein, in a cooling mode of the air conditioner, the on comfortable temperature is set higher than the off comfortable temperature by a predefined critical temperature due to the drive of the air conditioner, and
in a heating mode of the air conditioner, the on comfortable temperature is set lower than the off comfortable temperature by the predefined critical temperature due to the drive of the air conditioner.

5. The apparatus of claim 1, wherein the control unit adjusts a reference comfortable temperature of a reference day predefined according to weather information of a target day of the zone to set a comfortable temperature of the target day.

6. The apparatus of claim 5, wherein the reference day corresponds to a clear day without cloud and precipitation.

7. The apparatus of claim 5, wherein the weather information includes an average outdoor temperature of day, and
the control unit calculates a difference between an outdoor temperature of the target day of the zone and an outdoor temperature of the reference day of the zone, and adjusts the reference comfortable temperature according to the temperature difference to set the comfortable temperature of the target day.

8. The apparatus of claim 7, wherein the control unit sets the comfortable temperature of the target day based on the following Equation:
Comfortable temperature of target day=Reference comfortable temperature−αΔTa
wherein, ΔTa represents the temperature difference, and a represents a temperature adjustment parameter, respectively.

9. The apparatus of claim 5, wherein the weather information includes a cloud amount of a day, and
the control unit calculates a difference between a cloud amount of the target day of the zone and a cloud amount of the reference day of the zone, and adjusts the reference comfortable temperature according to the cloud amount difference to set the comfortable temperature of the target day.

10. The apparatus of claim 9, wherein the control unit sets the comfortable temperature of the target day based on the following Equation:
Comfortable temperature of target day=Reference comfortable temperature+βΔC
wherein, ΔC represents the cloud amount difference, and β represents a cloud amount adjustment parameter, respectively.

11. The apparatus of claim 5, wherein the weather information includes precipitation information of day, and
the control unit calculates a difference between a precipitation of the target day of the zone and a precipitation of the reference day of the zone, and adjusts the reference comfortable temperature according to the precipitation difference to set the comfortable temperature of the target day.

12. The apparatus of claim 11, wherein the precipitation information of the day includes a precipitation probability of day and a precipitation type of day,
the control unit determines that the precipitation has occurred when the precipitation probability is greater than or equal to a preset threshold probability, and determines that the precipitation has not occurred when the precipitation probability is less than the threshold probability, and
the control unit sets the comfortable temperature of the target day based on the following Equation:
Comfortable temperature of target day=Reference comfortable temperature+γΔR−δΔS
wherein, ΔR represents a first precipitation difference for rain, ΔS represents a second precipitation difference for snow, γ represents a rain adjustment parameter, and δ represents a snow adjustment parameter, respectively.

13. The apparatus of claim 5, wherein the weather information includes an average outdoor temperature of day, an average cloud amount of day, and precipitation information of day, and
the control unit calculates a difference between an average outdoor temperature of the target day of the zone and an average outdoor temperature of the reference day of the zone, a difference between an average cloud amount of the target day of the zone and an average cloud amount of the reference day of the zone, a difference between a precipitation of the target day of the zone and a precipitation of the reference day of the zone, and adjusts the reference comfortable temperature according to the temperature difference, the cloud amount difference, and the precipitation difference to set the comfortable temperature of the target day.

14. The apparatus of claim 5, wherein each of the reference comfortable temperature and the comfortable temperature of the target day are set by sequential period included in the day,
the reference comfortable temperature for each period is set by applying a predefined period correction parameter to a representative reference comfortable temperature which is the reference comfortable temperature of the reference period included in the reference day, and
the period correction parameter is defined based on at least one of a sunrise/sunset time of the reference day and the average outdoor temperature of the reference day.

15. A system for controlling an air conditioner installed in an indoor zone, comprising:
a temperature sensor that measures an indoor temperature of the zone;
a gateway that receives the indoor temperature from the temperature sensor;
a management server that receives weather information of the zone provided from a weather server and the indoor temperature transmitted from the gateway, respectively, sets an off comfortable temperature, which is a perceived comfort temperature of a user located in the zone when the air conditioner is turned off, and an on comfortable temperature, which is the perceived comfort temperature of the user when the air conditioner is turned on, based on the weather information, and generates a drive control signal of the air conditioner based on the indoor temperature, the off comfortable temperature, and the on comfortable temperature; and
a control module that receives the drive control signal transmitted from the management server through the gateway and transmits the drive control signal to the air conditioner.

16. A method for controlling an air conditioner installed in an indoor zone, performed on a processor-based apparatus, the method comprising:
receiving weather information of the zone provided from a weather server;
setting an off comfortable temperature, which is a perceived comfort temperature of a user located in the zone, when the air conditioner is turned off and an on comfortable temperature, which is the perceived comfort temperature of the user located in the zone when the air conditioner is turned off, based on the weather information;
receiving an indoor temperature measured in the zone; and
generating a drive control signal of the air conditioner based on the indoor temperature, the off comfortable temperature, and the on comfortable temperature.
